(19) United States
(12) Patent Application Publication
(10) Pub. No.: US 2025/0251484 A1
(43) Pub. Date: Aug. 7, 2025

(54) CONVENTION WAYFINDING SYSTEM

(71) Applicant: PHUNWARE, INC., Austin, TX (US)

(72) Inventors: Andrew Soltan, Orange, CA (US); Troy Stump, Irvine, CA (US); Kent Tu, Orange, CA (US)

(21) Appl. No.: 18/431,975

(22) Filed: Feb. 3, 2024

(51) Int. Cl. G01S 5/02

(52) U.S. Cl. CPC G01S 5/02526; G01S 2205/02

(57) ABSTRACT

A computer implemented method for wayfinding in a reconfigurable environment includes: developing with a beacon detector mobile device having a processor and a memory a plurality of fixed location fingerprints derived from a plurality of beacon transmissions received at a plurality of fixed locations arranged in a grid pattern as an X-Y array within a reconfigurable environment; developing with a mapping server having a microprocessor and a memory a navigable pathways map from the plurality of fixed location fingerprints and a configuration map of the reconfigurable environment; and displaying with a user mobile device having a processor and memory the navigable pathways map to provide wayfinding for a user within the reconfigurable environment.

### BACKGROUND

Various technologies have been developed for tracking a user's indoor location and displaying it on a map on a mobile device. These technologies typically include hardware to be installed onsite which the mobile device connects to in order to triangulate the user's location based on how far the user is from each of these hardware devices. The hardware devices may include Bluetooth Low Energy Beacons (BLE), WiFi Access Points, or other Bluetooth devices such as lights or badge readers. Hardware-based wayfinding is preferred indoors because Global Positioning System (GPS) signals are often inaccurate indoors and are unable to provide floor-specific signals.

Mobile devices can be programmed to provide indoor wayfinding. For example, in a store there are rows of shelves and displays which rarely move. Possible routes can be determined by walking all of the aisles while monitoring for strategically placed beacons. This can be a time consuming task, but generally only has to be done once, unless the configuration of the store is changed.

Frequent route re-mapping is a problem encountered in reconfigurable environments, such as a convention center. Conventions tend to be of relatively short duration, e.g., a week or less, which means that the configuration of the convention center is changing constantly. This makes the cost in time and money to frequently update routes in a convention center quite high.

These and other limitations of the prior art will become apparent to those of skill in the art upon a reading of the following descriptions and a study of the several figures of the drawing.

### SUMMARY

A reconfigurable environment wayfinding system includes: a beacon detector mobile device capable of being moved within a reconfigurable environment that is provided with a plurality of beacons, wherein the beacon detector mobile device is receptive to beacon transmissions of the plurality of beacons and is operative to develop fixed location fingerprints at a plurality of fixed locations within the reconfigurable environment; a mapping server receptive to the fixed location fingerprints and to a configuration map of the reconfigurable environment and operative to develop a navigable pathways map for the reconfigurable environment; and a user mobile device receptive to the beacon transmissions of the plurality of beacons and to the navigable pathways map and operative to provide wayfinding for the user within the reconfigurable environment.

A computer implemented method for wayfinding in a reconfigurable environment includes: developing with a beacon detector mobile device having a processor and a memory a plurality of fixed location fingerprints derived from a plurality of beacon transmissions received at a plurality of fixed locations arranged in a grid pattern as an X-Y array within a reconfigurable environment; developing with a mapping server having a microprocessor and a memory a navigable pathways map from the plurality of fixed location fingerprints and a configuration map of the reconfigurable environment; and displaying with a user mobile device having a processor and memory the navigable pathways map to provide wayfinding for a user within the reconfigurable environment.

A computer readable media including code segments executable by a processor for: developing a plurality of fixed location fingerprints from a plurality of beacon transmissions received at a plurality of fixed locations arranged in a grid pattern as an X-Y array within a reconfigurable environment; developing a navigable pathways map from the plurality of fixed location fingerprints and a configuration map of the reconfigurable environment; and displaying the navigable pathways map to provide wayfinding for a user within the reconfigurable environment.

An advantage of embodiments disclosed herein is that the fingerprinting of potential waypoints in a reconfigurable environment only has to be done once, facilitating a quick update of wayfinding services as the environment is reconfigured.

These and other embodiments, features and advantages will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, but not to limit, the invention. The drawings include the following figures:

FIG. 1 is an illustration of a convention wayfinding system;

FIG. 2A is a front view of an example mobile device;

FIG. 2B is a rear view of the example mobile device of FIG. 2A;

FIG. 3 is a block diagram of an example mobile device;

FIG. 4 is a block diagram of an example server device;

FIG. 5 is a partially broken, perspective view of an example reconfigurable environment;

FIG. 6 is a graph illustrating the relationship between RSSI levels and the distance to a Bluetooth beacon;

FIG. 7 is a flow diagram of a computer implemented method for wayfinding;

FIG. 8 is a flow diagram illustrating the operation 118 of FIG. 7 in greater detail;

FIG. 9 is an illustration of an X-Y array grid pattern of fixed locations on the floor of a reconfigurable environment;

FIG. 10 is an illustration of database table for fixed location fingerprints on the floor of a reconfigurable environment;

FIG. 11 is a flow diagram illustrating the operation 120 of FIG. 7 in greater detail;

FIG. 12 illustrates the superposition of a configuration map on the grid pattern of the floor of the reconfigurable environment;

FIG. 13 further illustrates the superposition of a configuration map of the grid pattern of the floor of the reconfigurable environment;

FIG. 14 is an illustration of the database table of FIG. 10 with inaccessible fixed locations being flagged;

FIG. 15 is a flow diagram illustrating the operation 122 of FIG. 7 in greater detail; and

FIGS. 16A and 16B illustrate a user mobile device being used for convention wayfinding.

### DETAILED DESCRIPTION OF EXAMPLE EMBODIMENTS

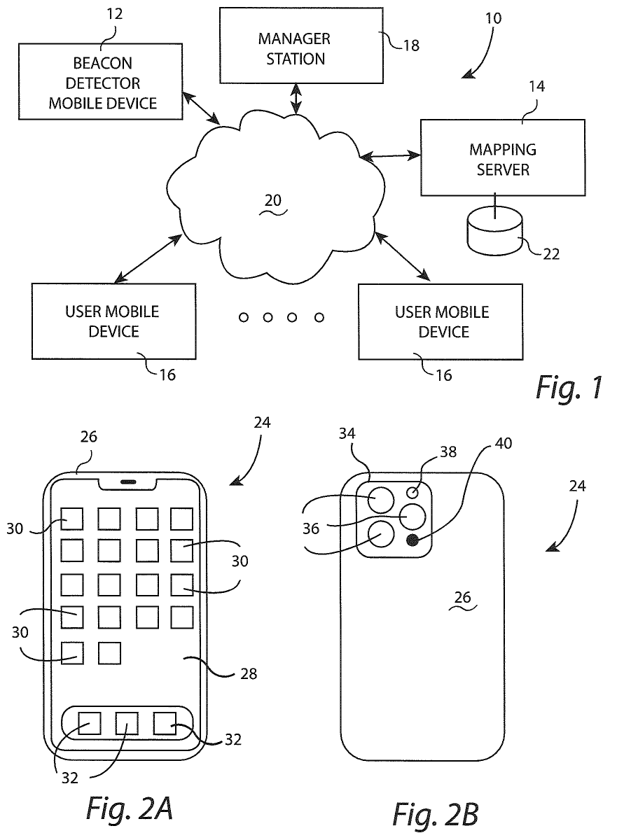

In FIG. 1, an example reconfigurable environment wayfinding system 10 is shown to include a beacon detector mobile device 12, a mapping server 14, a plurality of user mobile devices 16, and a manager station 18. Mapping server 14, in this example, can communicate with beacon detector mobile device 12, the plurality of user devices 16, and manager station 18 via a network such as the internet 20. A mapping server database 22 can store fixed location fingerprints for a reconfigurable environment.

FIGS. 2A and 2B are front and back views of an example mobile device (“smartphone”) 24 which, with suitable software, can be used for as a hardware/software platform for the beacon detector mobile device 12 and/or the user mobile device 16. For example, smartphone 24 can be an iPhone™ 13 Pro made by Apple, Inc. of Cupertino, California.

With reference to FIG. 2A, the smartphone 24 has a case 26 and a touchscreen 28 displaying a number of home screen application (“app”) icons 30 and a number of fixed screen app icons 32. Tapping an app icon on the touchscreen 28 launches the associated app. In FIG. 2B the back of mobile device 24 includes the case 26 and an area 34 provided with the lenses of three cameras 36, a flash 38, and a LiDAR module 40.

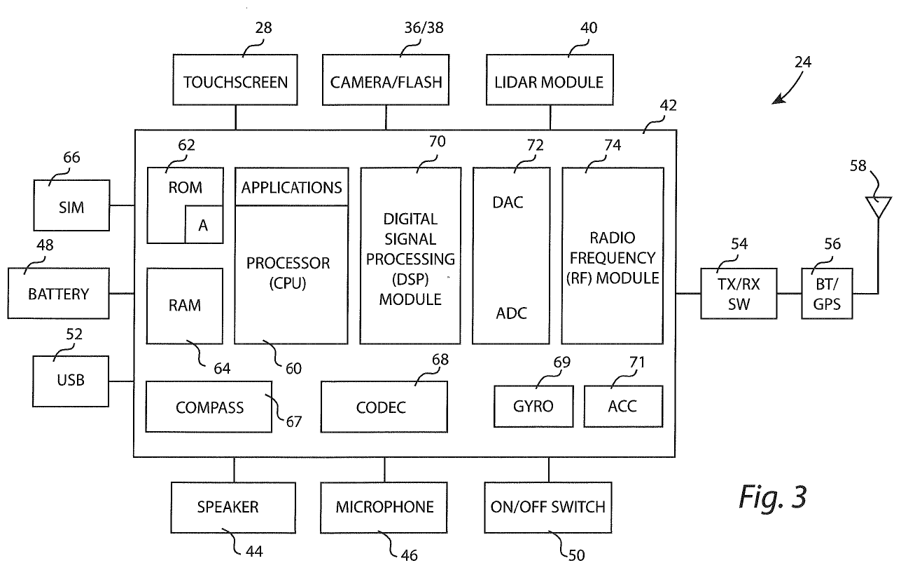

FIG. 3 illustrates, by way of example and not limitation, an electronic block diagram of a mobile device 24 including main circuitry 42 and input/output (I/O) components such as touchscreen 28, camera/flash unit 36/38, LiDAR module 40, speaker 44, and microphone 46. Main circuitry 42 is powered by a battery 48 and is turned on and off with a switch 50. In this example embodiment, the main circuitry 42 is provided with a universal serial bus (USB) 52. A transmit/receive (Tx/Rx) switch 54 and a Bluetooth/GPS (BT/GPS) module 56 couple an antenna 58 to the main circuitry 42. It should be noted that the BT/GPS module 56 can be reconfigured as separate Bluetooth (BT) and Global Positioning System (GPS) modules, each with access to its own antenna.

Main circuitry 42 of mobile device 24 includes a processor (CPU) 60, capable of running applications (apps) and read only memory (ROM) 62 coupled to the CPU 60. ROM 62 can be, for example, an electrically erasable, programmable read only memory (EEPROM) or flash memory and can store data, code segments and objects such as an app “A.” Other memory include random access memory (RAM) 64, and a removable subscriber identity module (SIM) 66 which identifies the subscriber and device. The example main circuitry 42 also includes a compass 67, a CODEC 68, a gyroscope (GYRO) 69, a baseband processing and audio/speech processing digital signal processor (DSP) 70, an accelerometer (ACC) 71, a digital to analog converter (DAC) and analog to digital converter (ADC) 72, and a radio frequency (RF) module 74 for frequency conversion, power amplification, etc.

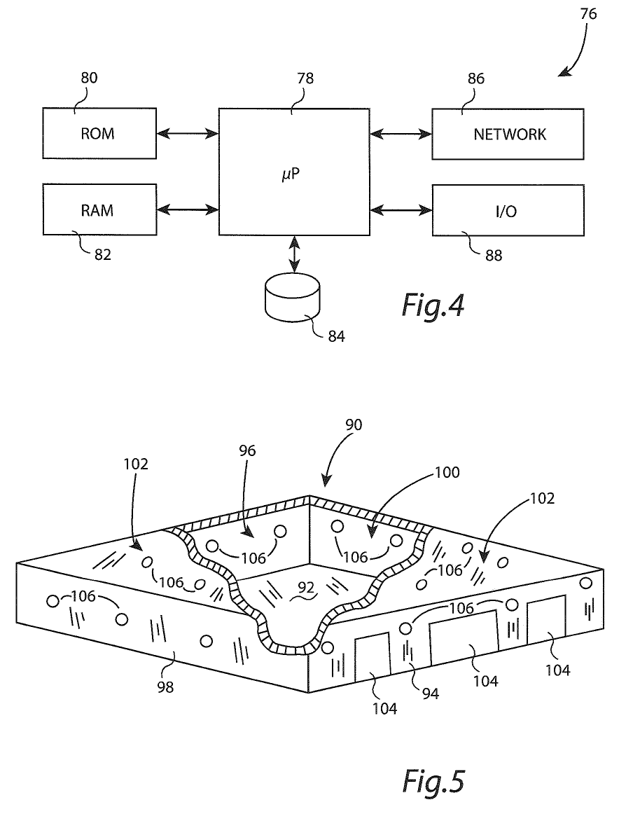

In FIG. 4, an example computer 76 includes a microprocessor (μP) 78, read only memory (ROM) 80, random access memory (RAM) 82, mass storage 84, a network interface 86, and input/output (I/O) 88. Computer 76 is suitable for use as a manager station 18, where the I/O 88 includes a computer monitor, keyboard and mouse, or as mapping server 14, where the mass storage 84 can be separate from or include the mapping server database 22. The computer 76 can also be used to combine the functions of the mapping server 14 and the management station 18 as a combined computer/server.

In FIG. 5, an example reconfigurable environment 90 is a large room having a floor 92, front wall 94, a rear wall 96, a left side wall 98, a right side wall 100, and a roof or ceiling 102. Doors 104 in front wall 94 allow for ingress and egress to the reconfigurable environment 90 which can be, for example, a room or hall in a convention center. In this example, the reconfigurable environment 90 can be 10,000 square feet, with a 100′×100′ floor 92. Ceiling heights can vary substantially but tend to be quite tall, e.g., 20-40 feet. It should be noted that the reconfigurable environment can be of many shapes and sizes, and may include non-reconfigurable structures such as support columns, rest room facilities, etc.

By “reconfigurable environment,” it is meant that the position of structures, objects and/or other impediments to motion can be changed to suit different purposes for the environment. In the example of a room in a convention center, booths and displays within the room tend to change with every new convention. As a result, navigating or “wayfinding” within the room changes with every reconfiguration of the environment.

The example reconfigurable environment 90 is provided with a plurality of beacons 106 which can be supported on or in the walls 94, 96, 98 and 100 or on or in the ceiling 106. It is preferable to position the beacons high enough to prevent tampering, but they can also be positioned lower on the walls, on permanent structures within the environment 90, such as support columns, or even in the floor 92 with adequate protection. The beacons 106 are preferably positioned so as to provide clear line of sight to mobile devices within the environment 90 to minimize signal loss or blockage.

An example beacon is the Bluetooth beacon, which is a class of Bluetooth Low Energy (BLE) hardware transmitter which broadcasts a unique identifier and several bytes of information that can be received by nearby Bluetooth enabled portable electronic devices. The Bluetooth beacon makes a 1-way transmission to the receiving smartphone 24. Thus, only the smartphone 24 with an installed app, and not the beacon, can track users.

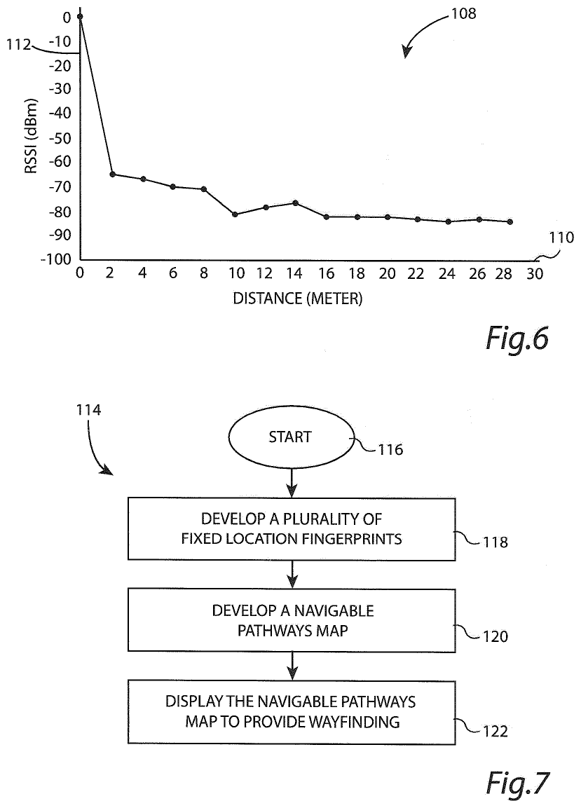

A Received Signal Strength Indicator (RSSI) measurement of a beacon signal can be used to determine roughly how far the mobile device is from a beacon. As seen in FIG. 6, RSSI is only roughly accurate for several meters in measuring distances. Furthermore, the RSSI measurement is affected by signal blockage, orientation of the mobile device, and other factors which can make a direct measurement of distance from the beacon problematical.

In theory, Bluetooth beacons have a maximum range of up to 300 feet (100 meters). It is quite likely that a smartphone 24 within the reconfigurable environment 90 will receive beacon transmissions from most if not all of the beacons 106.

In FIG. 6, a graph 108 of the relationship between RSSI and the distance a Bluetooth beacon is illustrated. The ordinate (“X”) axis 110 has units of meters and the abscissa (“Y”) axis 112 has units of dBm (decibel-milliwatts). As can be seen, the RSSI value has a fairly linear negative slope from about 0 to 2 meters, and then begins to flatten out. When used for location, it is therefore desirable to favor Bluetooth beacons that are closer to the measurement device.

In FIG. 7, a computer implemented method 114 for wayfinding in a reconfigurable environment begins at 116 and, in an operation 118, develops a plurality of fixed location fingerprints derived from a plurality of beacon transmissions received at a plurality of fixed locations arranged in a grid pattern as an X-Y array within a reconfigurable environment. Next, in an operation 120, a navigable pathways map is developed from the plurality of fixed location fingerprints and a configuration map of the reconfigurable environment. Finally, in an operation 122, the navigable pathways map is displayed, e.g., on a smartphone 24, to provide wayfinding within the reconfigurable environment.

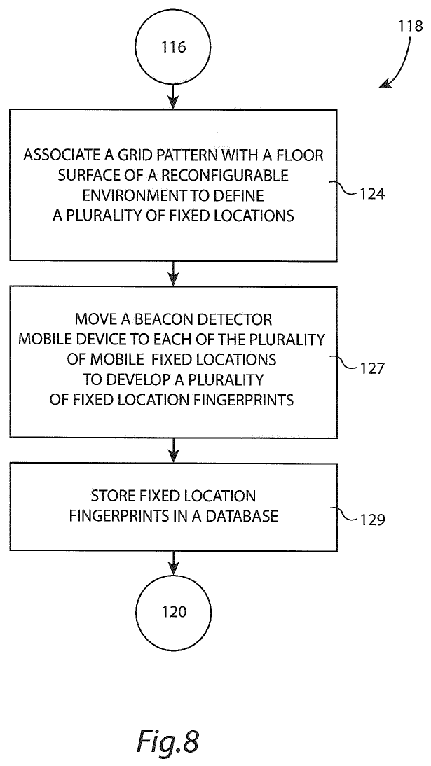

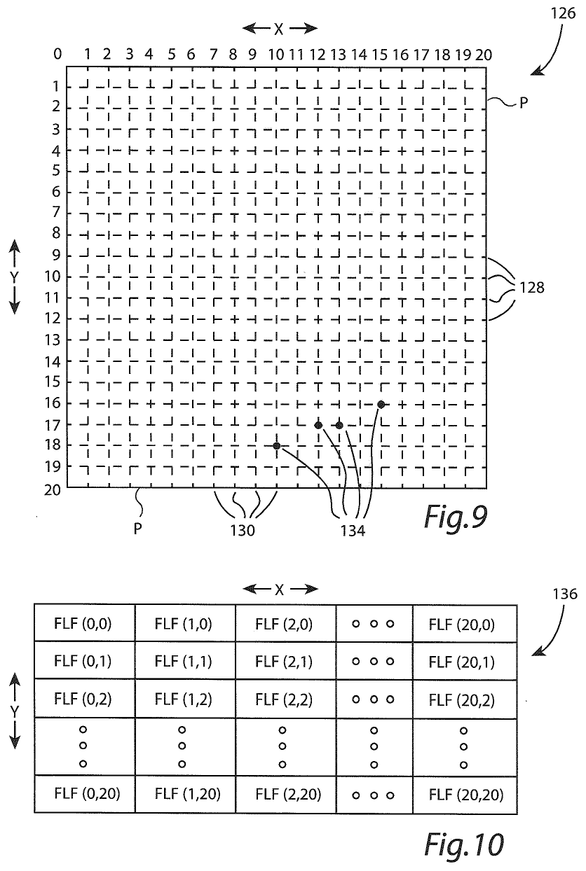

FIG. 8 is a flow diagram illustrating operation 118 of FIG. 7 in greater detail. With additional reference to the illustration of FIG. 9, operation 118 begins with an operation 124 which associates a grid pattern 126 with a floor surface (e.g., floor 92 of FIG. 5) of a reconfigurable environment (e.g., environment 90 of FIG. 5) to define a plurality of fixed locations with respect to the floor surface. The grid pattern 126 can be visualized as a series of broken lines 128 parallel to an X axis and a series of broken lines 130 parallel to a Y axis. The grid pattern 126 can therefore be considered to be an X-Y array. Fixed locations 134 are found at the intersection of broken lines 128 and 130, and at the intersection of the broken lines with the four sides of the perimeter P of the grid pattern 126.

In this example, the grid pattern 126 is considered to represent 100 feet on each of its four sides, for a total area of 10,000 square feet of floor area. The broken lines 128 and 130 can be considered to be 5 feet apart, resulting in a 20×20 grid. The grid pattern 126 can be real or virtual, temporary or permanent. For example, the grid pattern 126 can be formed with chalk lines on the floor surface. Alternatively, the fixed locations 134 at the intersections of the grid pattern may be marked on the floor surface. Laser projection, measuring wheels, and automated mobile robotic grid marking systems can also be used. In some instances the termination of the broken line 128 and 130 at the perimeter walls will be used as fixed locations 134, and in other instances they will not.

With continuing reference to FIGS. 8 and 9, and with additional reference to FIG. 3, operation 118 continues with an operation 127 wherein a beacon detector mobile device 12 is moved to each of the plurality of fixed locations to develop a plurality of fixed location fingerprints. The beacon detector mobile device 12 can conveniently be a smartphone 24 having a Bluetooth module 56 and being capable of running an application (“app”) “A” stored in its ROM 62 memory to facilitate the creation of fixed location fingerprints. The smartphone 24 can be moved manually or automatically from fixed location to fixed location. For example, a technician can walk the smartphone 24 to the fixed locations, or an automated mobile robotic system can perform the same task.

At each location, a “fingerprint” is developed by the smartphone 24 based upon a number of received beacon transmissions. Since many environments, such as a convention hall, has dimensions within a Bluetooth beacon's range, the smartphone is likely to receive a good number of beacon transmissions, each including its own ID code. When the smartphone is in position at a fixed location 134, the app is activated to capture the RSSI values of the received beacon transmissions, and to use the strongest RSSI values, along with its associated ID, as a basis for the fixed location fingerprints. For example, the app can hash the top three RSSI values along with their associated beacon IDs to create a fingerprint for each fixed location 134.

As will be appreciated by those of skill in the art, there are a number of hash techniques for creating fingerprints. A one-way hash function takes a variable length input string and converts it into a fixed-length binary sequence. It is designed in such a way that it is hard to reverse the process, that is, to find a string that hashes to a given value. There are several methods to use a block cipher to build a cryptographic hash function, specifically a one-way compression function. The methods resemble the block cipher modes of operation usually used for encryption. Hamy well-known has functions, including MD4, MD5, SHA-1 and SHA-2 are built from block-cipher-like components designed for the purpose.

With continuing reference to FIG. 8, the process of operation 118 concludes with operation 129 which stores the fixed location fingerprints in a database, such as in mapping server database 22 of FIG. 1. By way of example, in FIG. 10 a simple table can be used as a database 136. In this example, a two-dimensional array FLF (x,y) is used to store the fixed location fingerprints at corresponding fixed locations 134. Since the first column and the first row of the table represent fixed locations along the perimeter walls P, they may be omitted in certain embodiments.

A fixed location fingerprint value can be retrieved from the database 136 by providing the x and y coordinates of the fixed location 134, e.g., fingerprint value at location (x,y)=FLF (x,y). However, this can be a cumbersome searching technique, and other database structures can be considered. For example, a content-addressable database can be used to search for fingerprints in a given range.

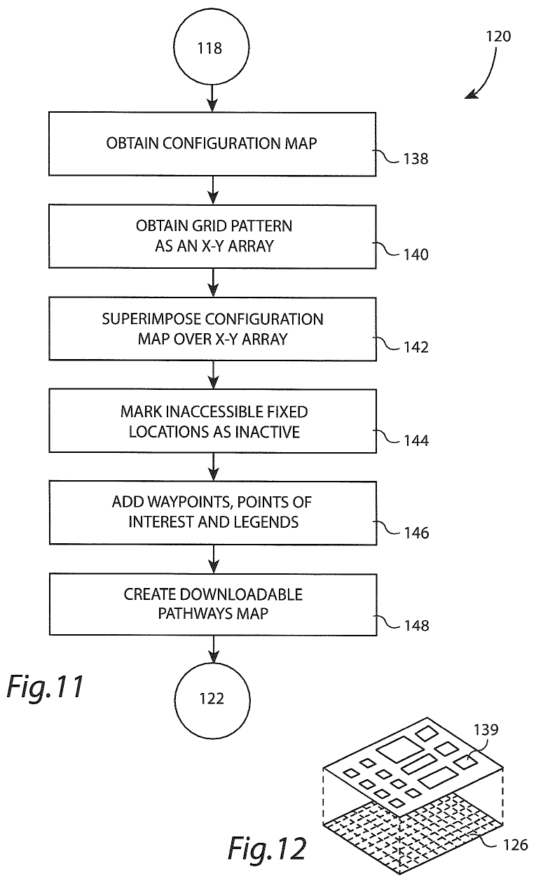

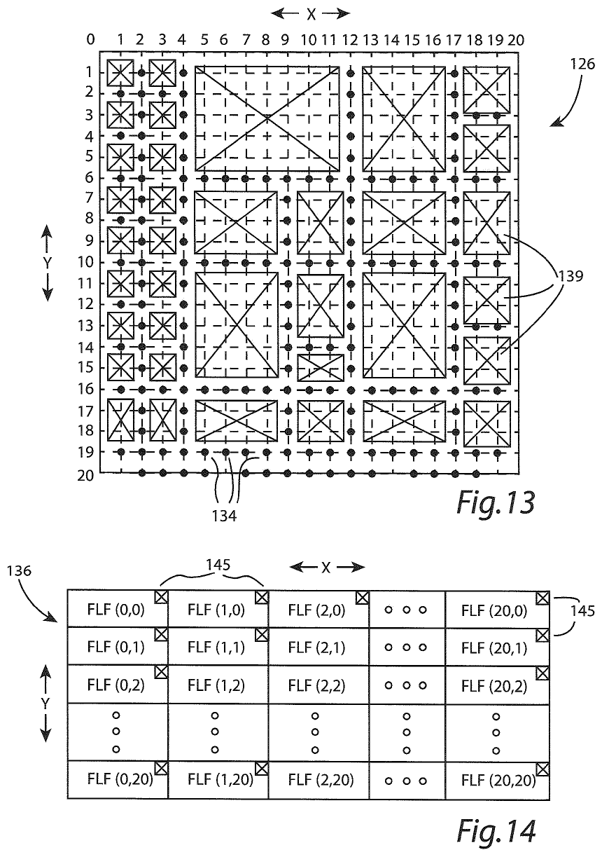

In the flow diagram of FIG. 11, an example operation 120 of FIG. 7 is discussed in greater detail. Operation 120 begins with an operation 138 which obtains a configuration map 139 for the reconfigurable environment 90. In the convention hall example, a configuration map 139 includes areas for vendor booths, displays, common areas, refreshment areas, etc. Next, in an operation 140, the grid pattern 126 as an X-Y array is obtained and, in an operation 142, the configuration map 139 is superimposed upon the grid pattern 126. See, additionally, FIGS. 12 and 13. With additional reference to FIG. 14, in an operation 144, fixed locations 134 that are covered by the configuration map 139 are marked as inactive in the database 136 by setting flags 145 in the FLF (x,y) array, because those fixed locations are generally inaccessible to the attendees of the convention and therefore are not used for wayfinding. The remaining fixed locations 134 can serve as waypoints during a wayfinding session. Next, points of interest, vendor booths, legends and other indicia can be added in an operation 146, and a downloadable pathways map is created by operation 148.

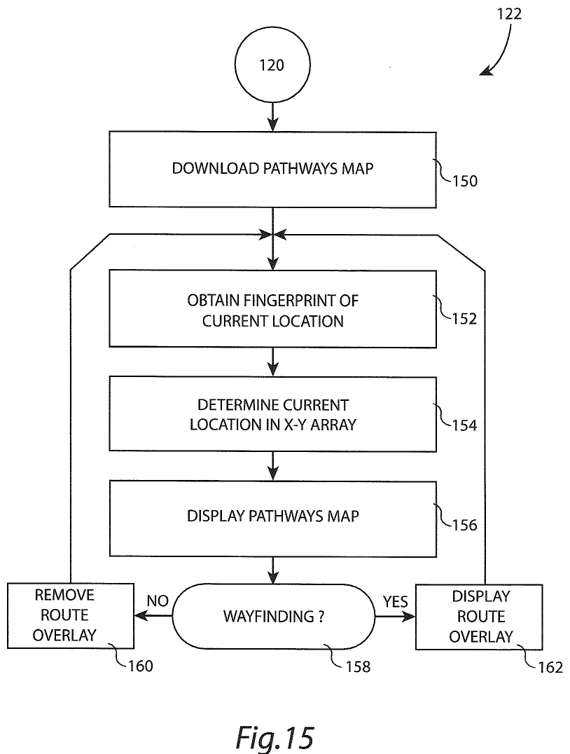

In FIG. 15, an example method of operation 122 of FIG. 7 is illustrated in greater detail. In an operation 150 the pathways map along with at least a subset of the fixed location fingerprint database are downloaded to a user mobile device 16 and, in an operation 152 a fingerprint of the current location of user mobile device is obtained in the same fashion that the beacon detector mobile device obtained the fixed location fingerprints. The user's current location fingerprint is compared to the downloaded fixed location fingerprint, where the inactivated fingerprints are ignored as not being a valid waypoints for the user. The best fingerprint match provides a tentative x-y position of the user on the X-Y array of grid pattern 126, which can be further verified using compass, gyroscope, and accelerometer data of the smartphone 24. An operation 156 then displays the pathway map on the user mobile device with the user's current location indicated on the map. If an operation 158 determines that the user mobile device 16 is not in a wayfinding mode, any route overlays are removed in an operation 160 and control returns to operation 152. If user mobile device 16 is in a wayfinding mode (e.g., a destination has been input), then an operation 162 displays a route overlay. For example, the route overlay can include an icon indicating the destination, an icon (e.g., a blinking dot) for the user's current location, and a route line with direction arrows connecting the user's current location to the destination.

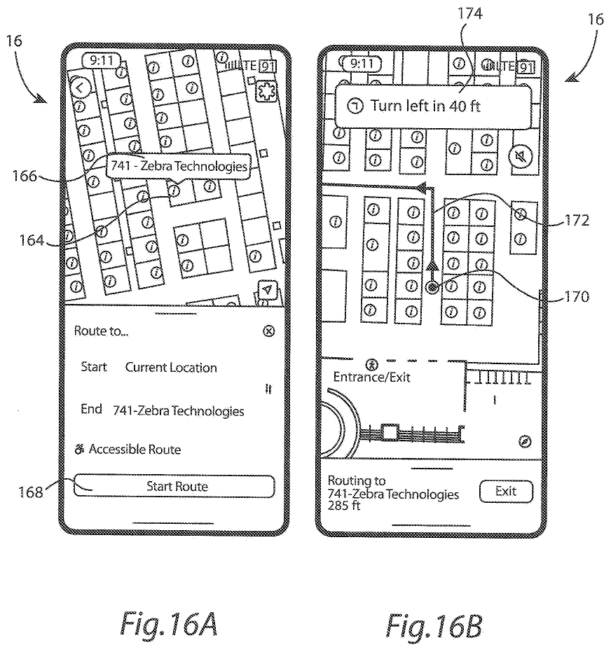

FIGS. 16A and 16B illustrates an example wayfinding session on a user mobile device 16. In FIG. 16A, a user requests a route to the booth for Zebra Technologies from their current location. The location of the Zebra Technologies booth on the X-Y array of grid pattern 126 is part of the pathways map, and an icon 164 and a legend 166 for the Zebra Technologies booth are displayed.

FIG. 16B illustrates how the display of the user mobile device changes after the “Start Route” button 168 of FIG. 16A is pressed. In FIG. 16B, an icon 170 indicates the user's current position and a route line 172 with direction arrows shows the way. Turn-by-turn instructions are provided on a banner 174. The route line can be conveniently calculated by connecting the current location of the user to the destination with a connection line, and then following the closest vertical and horizontal paths matching the connection line. More elaborate algorithms can also be used to take into account congestion, ease of route, etc. Wayfinding mode can be automatically turned off when the user reaches the destination, or manually by pressing the “Exit” button 176 of FIG. 16B.

Although various embodiments have been described using specific terms and devices, such description is for illustrative purposes only. The words used are words of description rather than of limitation. It is to be understood that changes and variations may be made by those of ordinary skill in the art without departing from the spirit or the scope of various inventions supported by the written disclosure and the drawings. In addition, it should be understood that aspects of various other embodiments may be interchanged either in whole or in part. It is therefore intended that the claims be interpreted in accordance with the true spirit and scope of the invention without limitation or estoppel.

1. A reconfigurable environment wayfinding system comprising:
a beacon detector mobile device capable of being moved within a reconfigurable environment that is provided with a plurality of beacons, wherein the beacon detector mobile device is receptive to beacon transmissions of the plurality of beacons and is operative to develop fixed location fingerprints at a plurality of fixed locations within the reconfigurable environment;
a mapping server receptive to the fixed location fingerprints and to a configuration map of the reconfigurable environment and operative to develop a navigable pathways map for the reconfigurable environment; and
a user mobile device receptive to the beacon transmissions of the plurality of beacons and to the navigable pathways map and operative to provide wayfinding for the user within the reconfigurable environment.

2. A reconfigurable environment wayfinding system as recited in claim 1 wherein the plurality of fixed locations are arranged in a grid pattern.

3. A reconfigurable environment wayfinding system as recited in claim 2 wherein the beacon detector mobile device calculates a fixed location fingerprint from beacon transmissions received at fixed locations on the grid pattern.

4. A reconfigurable environment wayfinding system as recited in claim 3 wherein the beacon detector mobile device calculates a fixed location fingerprint by ranking beacon transmissions by respective Received Signal Strength Indicator (RSSI) measurements.

5. A reconfigurable environment wayfinding system as recited in claim 4 wherein the fixed location fingerprints are calculated using a subset of the received beacon transmissions at the fixed location that have the highest RSSI measurements.

6. A reconfigurable environment wayfinding system as recited in claim 5 wherein each beacon transmission includes a beacon ID.

7. A reconfigurable environment wayfinding system as recited in claim 6 wherein a fixed location fingerprint includes a hash including a plurality of beacon IDs and associated RSSI measurements.

8. A reconfigurable environment wayfinding system as recited in claim 2 wherein the grid pattern of locations are arranged as an X-Y array.

9. A reconfigurable environment wayfinding system as recited in claim 8 wherein the fixed location fingerprints are stored in a fixed location fingerprint database that can be accessed by the mapping server.

10. A reconfigurable environment wayfinding system as recited in claim 9 wherein the mapping server maps the configuration map of the reconfigurable environment to the X-Y array to develop a subset of the fixed location fingerprint database with inaccessible fixed locations disabled and with a plurality of accessible fixed locations designated as waypoints to provide the navigable pathways map.

11. A reconfigurable environment wayfinding system as recited in claim 1 wherein the user mobile device is a smartphone provided with an app stores the navigable pathways map on the smartphone to facilitate offline wayfinding within the reconfigurable environment.

12. A reconfigurable environment wayfinding system as recited in claim 11 wherein the smartphone is receptive to beacon transmissions of the plurality of beacons and is operative to develop a current location fingerprint.

13. A reconfigurable environment wayfinding system as recited in claim 12 wherein the smartphone compares the current location fingerprint to the pathways map to determine a current location on the navigable pathways map.

14. A reconfigurable environment wayfinding system as recited in claim 13 wherein the smartphone provides wayfinding to a designated waypoint using the current location and the navigable pathways map.

15. A reconfigurable environment wayfinding system as recited in claim 14 wherein the smartphone includes one or more of a compass, a gyroscope, and a GPS module.

16. A reconfigurable environment wayfinding system as recited in claim 15 wherein the current location fingerprint is calculated as a weighted average of the fixed location signature and one or more of a compass measurement, a gyroscope measurement, a GPS measurement and an accelerometer measurement by the user mobile device.

17. A computer implemented method for wayfinding in a reconfigurable environment comprising:
developing with a beacon detector mobile device having a processor and a memory a plurality of fixed location fingerprints derived from a plurality of beacon transmissions received at a plurality of fixed locations arranged in a grid pattern as an X-Y array within a reconfigurable environment;
developing with a mapping server having a microprocessor and a memory a navigable pathways map from the plurality of fixed location fingerprints and a configuration map of the reconfigurable environment; and
displaying with a user mobile device having a processor and memory the navigable pathways map to provide wayfinding for a user within the reconfigurable environment.

18. A computer implemented method for wayfinding in a reconfigurable environment as recited in claim 17 wherein the mapping server maps the configuration map of the reconfigurable environment to the X-Y array to develop a subset of the location fingerprint database with inaccessible locations disabled.

19. A computer implemented method for wayfinding in a reconfigurable environment as recited in claim 18 wherein the user mobile device provides wayfinding to a designated waypoint using a current location fingerprint and the navigable pathways map.

20. A computer readable media including code segments executable by a processor for:
developing a plurality of fixed location fingerprints from a plurality of beacon transmissions received at a plurality of fixed locations arranged in a grid pattern as an X-Y array within a reconfigurable environment;
developing a navigable pathways map from the plurality of fixed location fingerprints and a configuration map of the reconfigurable environment; and
displaying the navigable pathways map to provide wayfinding for a user within the reconfigurable environment.
